(19) United States
(12) Patent Application Publication
(10) Pub. No.: US 2024/0373248 A1
(43) Pub. Date: Nov. 7, 2024

(54) METHOD FOR COMMON BEAM IDENTIFICATION AND RELATED APPARATUS

(71) Applicant: BEIJING UNISOC COMMUNICATIONS TECHNOLOGY CO., LTD., Beijing (CN)

(72) Inventor: Hualei WANG, Beijing (CN)

(21) Appl. No.: 18/260,330

(22) PCT Filed: Feb. 17, 2022
(86) PCT No.: PCT/CN2022/076633

§ 371 Date: Jul. 4, 2023

(30) Foreign Application Priority Data
Jan. 5, 2021 (CN) 202110008855.9

(51) Int. Cl. H04W 16/28; H04W 72/231; H04W 76/20

(52) U.S. Cl. CPC H04W 16/28; H04W 72/231; H04W 76/20

(57) ABSTRACT

A method for common beam identification includes: receiving a downlink control information (DCI) instruction, the DCI instruction containing a field indicating a common beam; and determining a downlink common beam and/or an uplink common beam according to the field indicating the common beam and MAC CE information configured by a network side.

### CROSS-REFERENCE TO RELATED APPLICATION(S)

This application is a National Stage of International Application No. PCT/CN2022/076633, filed Feb. 17, 2022, which claims priority to Chinese Application No. 202110008855.9, filed Jan. 5, 2021, both of which are incorporated by reference herein.

### TECHNICAL FIELD

The present disclosure relates to the field of communication technology, and in particular to a method for common beam identification and related apparatuses.

### BACKGROUND

In a new radio (NR) R15/R16, downlink control information may contain a transmission configuration indicator (TCI) field. The TCI field may be used to indicate beam information of a physical downlink share channel (PDSCH).

In the current NR R17, downlink common beam indication and uplink common beam indication are being discussed. It has been explicitly supported to indicate a downlink common beam by downlink control information (DCI).

However, there is no specific scheme for uplink common beam indication at present.

### SUMMARY

In a first aspect, embodiments of the disclosure provide a method for common beam identification, which includes the following: receiving a downlink control information (DCI) instruction, the DCI instruction containing a field indicating a common beam; and determining a downlink common beam and/or an uplink common beam according to the field indicating the common beam and MAC CE information configured by a network side.

In a second aspect, embodiments of the disclosure provide a terminal including a memory and a processor, where the memory stores a computer program capable of running in the processor, and the processor performs the method for common beam identification described above when executing the computer program.

In a third aspect, embodiments of the disclosure provide a non-transitory computer-readable storage medium storing a computer program which, when executed by a terminal, implements any of the method for common beam identification described above.

### BRIEF DESCRIPTION OF THE DRAWINGS

FIG. 1 is a flowchart of a method for common beam identification according to an embodiment of the present disclosure.

FIG. 2 is a schematic diagram of a frame structure of an MAC CE according to an embodiment of the present disclosure.

FIG. 3 is a schematic diagram of another frame structure of an MAC CE in an embodiment of the present disclosure.

FIG. 4 is a flowchart of another method for common beam identification according to an embodiment of the present disclosure.

FIG. 5 is a schematic structural diagram of an apparatus for common beam identification according to an embodiment of the present disclosure.

FIG. 6 is a schematic structural diagram of another apparatus for common beam identification according to an embodiment of the present disclosure.

### DETAILED DESCRIPTION

As described above, in the current NR R17, downlink common beam indication and uplink common beam indication are being discussed. It has been explicitly supported to indicate a downlink common beam by downlink control information (DCI), while there is no specific solution for uplink common beam indication.

In embodiments of the present disclosure, a downlink common beam and/or an uplink common beam are determined according to a field indicating a common beam and media access control (MAC) control element (CE) information configured by a network side, so that downlink common beam information and/or uplink common beam information can be indicated by the MAC CE, which fills the gap in the related art.

To make the objectives, features, and beneficial effects of the present disclosure clearer and more comprehensible, the following describes specific embodiments of the present disclosure in detail with reference to the accompanying drawings.

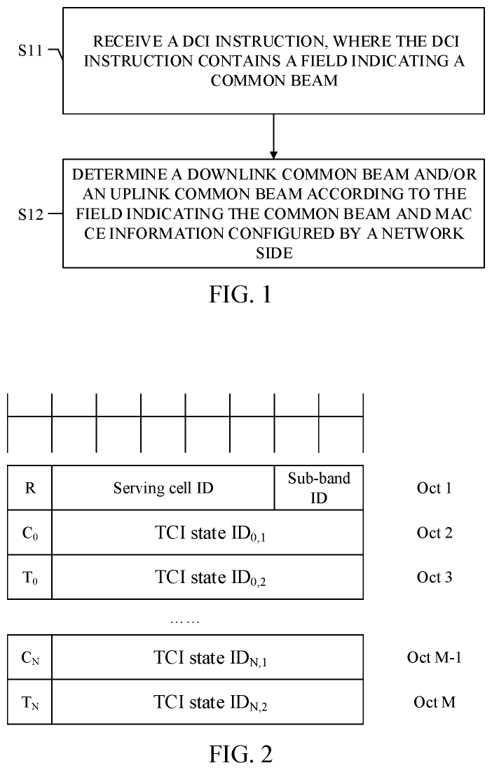

Referring to FIG. 1, FIG. 1 is a flowchart of a method for common beam identification according to an embodiment of the present disclosure. The method for common beam identification may include operations in S11 to S12.

In S11, receive a DCI instruction, where the DCI instruction contains a field indicating a common beam.

In S12: determine a downlink common beam and/or an uplink common beam according to the field indicating the common beam and MAC CE information configured by a network side.

In a specific embodiment of S11, the field indicating the common beam may be obtained by receiving the DCI instruction.

Further, the field may be used for indicating to the user equipment (UE) to use the MAC CE information configured by the network side.

Further, the field may contain codepoint index information (index of the codepoint). Specifically, the index of the codepoint of a DCI transmission configuration indication field specified in a communication protocol (e.g., TS 38.212) may be reused. Optionally, the index of the codepoint of another appropriate field may also be used.

In a specific embodiment of S12, the UE may determine the downlink common beam and/or the uplink common beam according to the field indicating the common beam and the MAC CE information configured by the network side.

Further, the operation of determining the downlink common beam and/or the uplink common beam according to the field indicating the common beam and the MAC CE information configured by the network side may include: determining activation indication information for a common beam pair according to the MAC CE information, and determining whether a common beam in the common beam pair is activated according to the activation indication information for the common beam pair, and determining the downlink common beam and/or the uplink common beam according to the field indicating the common beam and the activation indication information. Each common beam pair includes a downlink common beam and/or an uplink common beam.

Specifically, when the activation indication information is a preset value, the common beams in the common beam pair may be activated, where the preset value is 1 or 0.

More specifically, when the activation indication information is 1, the common beam in the common beam pair may be activated, or when the activation indication information is 0, the common beam in the common beam pair may be activated.

In the embodiments of the present disclosure, by determining the activation indication information for the common beam pair according to the MAC CE information, it can be determined whether the common beam in the common beam pair is activated, so that indication of the downlink common beam information and/or the uplink common beam information by the MAC CE can be effectively achieved.

Referring to FIG. 2, FIG. 2 is a schematic diagram of a frame structure of an MAC CE according to an embodiment of the present disclosure.

As shown, the MAC CE may include a protocol data unit (PDU) sub-header identity of a logical channel identity (eLCID). The following fields may be included.

Serving cell ID: may be used for indicating an identity of a serving cell to which the MAC CE is applicable, and the length of the field may be 5 bits.

Bandwidth Part (BWP) ID: may be used to indicate a downlink (DL) BWP and/or an associated uplink (UL) BWP, where the MAC CE is applied to the DL BWP and/or the associated UL BWP. For example, it may be a codepoint of a DCI BWP indicator field specified in TS 38.212. The length of the BWP ID field may be 2 bits.

Reserved bit R: for example, may be set to “0”.

Further, the MAC CE may contain a Ci field and/or a Ti field, where the Ci field indicates activation indication information for a downlink common beam in an (i+1)-th common beam pair, and the Ti field indicates activation indication information for an uplink common beam in the (i+1)-th common beam pair.

Specifically, the Ci field may indicate whether a first transmission configuration indicator (TCI) state ID (TCI state IDi,1) is valid/activated. If the Ci field is set to “1”, the TCI state IDi,1 is valid/activated. If the Ci field is set to “0”, the TCI state IDi,1 is invalid/unactivated.

The Ti field may indicate whether a second TCI state ID (TCI state IDi,2) is valid/activated. If the Ti field is set to “1”, the TCI state IDi,2 is valid/activated. If the Ti field is set to “0”, the TCI state IDi,2 is invalid/unactivated.

It should be noted that Ci and Ti should not be set to “0” at the same time.

In the embodiments of the present disclosure, by configuring that the MAC CE has the Ci field and/the Ti field, the Ci field indicating activation indication information for the downlink common beam in the (i+1)-th common beam pair, the Ti field indicating activation indication information for the uplink common beam in the (i+1)-th common beam pair, indication of the activation indication information by the MAC CE can be effectively achieved.

Further, the MAC CE may further contain a TCI state IDi,j field, where each TCI state IDi,j field indicates an j-th common beam in an (i+1)-th common beam pair, where i is a non-negative integer and j is a positive integer.

Specifically, this field may indicate a TCI state identified by the TCI state ID specified in the communication protocol, such as specified in TS 38.331.

In the above, i may be the codepoint index of the DCI transmission configuration indication field specified in a communication protocol, for example, specified in TS 38.212.

The TCI state IDi,j may represent the j-th TCI state indicated by the (i+1)-th codepoint in the DCI transmission configuration indication field. A TCI codepoint to which a TCI state is mapped may be determined by a sequential position in all TCI codepoints with a TCI state IDi,j field set, i.e., first TCI state ID0,1 and first TCI state ID0,2 (namely, the first common beam pair) are mapped to a TCI codepoint value 0, second TCI state ID1,1 and second TCI state ID1,2 (namely, the second common beam pair) are mapped to a TCI codepoint value 1, and so on.

Further, N represents the maximum number of common beam pairs, which can be set as up to 8 (that is, i may have a maximum value of 7), and j may have a maximum value of 2.

Specifically, the maximum number of activated TCI codepoints may be 8 and the maximum number of TCI states mapped to each TCI codepoint may be 2.

Further, the operation of determining the activation indication information for the common beam pair according to the MAC CE information includes: determining the TCI state IDi,j field in the MAC CE and a downlink common beam and/or an uplink common beam indicated by the TCI state IDi,j field by assigning codepoint index information of the field indicating the common beam to i; and determining activation indication information for the downlink common beam and/or the uplink common beam.

It should be noted that, in another specific embodiment of the present disclosure, the TCI state IDi,j may also be used for indicating downlink common Quasi co-location (QCL)-TypeA information, and/or QCL-TypeB information, and/or QCL-TypeC information, and/or QCL-TypeE information. The TCI state IDi,j may be further used for indicating uplink common path loss reference signal information and/or uplink common power control information.

QCL-TypeA may include, but not limited to, Doppler shift, Doppler spread, average delay, and delay spread. QCL-TypeB may include, but not limited to, Doppler shift and Doppler spread. QCL-TypeC may include, but not limited to, Doppler shift and average delay. In the embodiments of the present disclosure, by configuring that the MAC CE has the TCI state IDi,j field and determining the TCI state IDi,j field in the MAC CE and the downlink common beam and/or the uplink common beam indicated by the TCI state IDi,j field by assigning the codepoint index information to i, indication of the downlink common beam information and/or the uplink common beam information by the MAC CE can be effectively achieved.

Further, the MAC CE has all TCI state IDi,j fields, and for each TCI state IDi,j field, activation indication information corresponding thereto is adjacent to the TCI state IDi,j field.

Specifically, in a specific embodiment shown in FIG. 2, the MAC CE may be set to include all the TCI state IDi,j fields, and for each TCI state IDi,j field, activation indication information corresponding thereto is adjacent to the TCI state IDi,j field, so that the activation indication information and the TCI state IDi,j fields can be in one-to-one correspondence, which can directly indicate the respective common beam and whether the beam is activated.

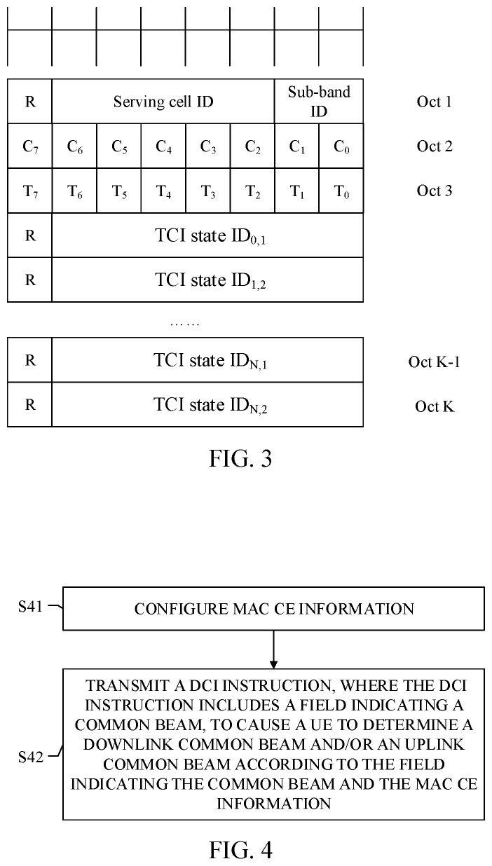

Referring to FIG. 3, FIG. 3 is a schematic diagram of another frame structure of the MAC CE according to an embodiment of the present disclosure.

In another specific embodiment shown in FIG. 3, the MAC CE has only TCI state IDi,j fields corresponding to activation indication information with a preset value, where the preset value is 1 or 0, and the fields corresponding to the activation indication information are arranged in sequence.

Specifically, the fields Ci of the respective activation indication information are arranged in sequence, and the fields Ti of the respective activation indication information are arranged in sequence.

In another specific embodiment of the present disclosure, it may be configured that the MAC CE has only TCI state IDi,j fields corresponding to activation indication information with a preset value, where the preset value is 1 or 0, and the fields corresponding to the activation indication information are arranged in sequence. In this way, the UE can determine activation states of all common beams only using some TCI state IDi,j fields, which can effectively reduce signalling overhead of the MAC CE.

In the embodiments of the disclosure, the downlink common beam and/or the uplink common beam are determined according to the field indicating the common beam and the MAC CE information configured by the network side, so that the MAC CE can be used to indicate the downlink common beam information and/or the uplink common beam information, which fills the gap in the related art.

Referring to FIG. 4, FIG. 4 is a flowchart of another method for common beam identification according to an embodiment of the present disclosure. The method for common beam identification may include operations in S41 to S42.

In S41: configure MAC CE information.

In S42: transmit a DCI instruction, where the DCI instruction includes a field indicating a common beam, to cause a UE to determine a downlink common beam and/or an uplink common beam according to the field indicating the common beam and the MAC CE information.

In the specific embodiment of S41, the network side may configure the MAC CE information.

The MAC CE information may be configured in a conventional manner with reference to descriptions in FIGS. 2 and 3.

In the embodiments of the present disclosure, the MAC CE information may be transmitted in a conventional and appropriate transmission manner, and the specific transmission manner of the MAC CE information is not limited.

In the specific embodiment of S42, transmitting the DCI instruction may include: transmitting the DCI instruction to cause the UE to determine activation indication information for a common beam pair according to the MAC CE information, determine whether a common beam in the common beam pair is activated according to the activation indication information for the common beam pair, and determine the downlink common beam and/or the uplink common beam according to the field indicating the common beam and the activation indication information, where each common beam pair includes a downlink common beam and/or an uplink common beam.

Further, the MAC CE may contain a Ci field and/or a Ti field, the Ci field indicating activation indication information for a downlink common beam in an (i+1)-th common beam pair, the Ti field indicating activation indication information for an uplink common beam in the (i+1)-th common beam pair, where i is a non-negative integer.

Further, the MAC CE may contain a TCI state IDi,j field, each TCI state IDi,j field indicating anj-th common beam in an (i+1)-th common beam pair, where i is a non-negative integer and j is a positive integer.

Further, the codepoint index information of the field indicating the common beam may be assigned to i, to cause the UE to determine the TCI state IDi,j field in the MAC CE and a downlink common beam and/or an uplink common beam indicated by the TCI state IDi,j field, and further determine activation indication information for the downlink common beam and/or the uplink common beam.

Further, in a specific embodiment of the present disclosure, the MAC CE may be set to contain all TCI state IDi,j fields, and for each TCI state IDi,j field, activation indication information corresponding thereto is adjacent to the TCI state IDi,j field.

Further, in another specific embodiment of the present disclosure, the MAC CE may be set to contain only TCI state IDi,j fields corresponding to activation indication information with a preset value, where the preset value is 1 or 0, and the fields corresponding to the activation indication information are arranged in sequence.

In the embodiments of the present disclosure, the downlink common beam and/or the uplink common beam are determined according to the field indicating the common beam and the MAC CE information configured by the network side, so that the MAC CE can be used to indicate the downlink common beam information and/or the uplink common beam information, which fills the gap in the related art.

Specifically, for more details about S41 and S42, reference may be made to the description of S11 and S12 in FIG. 1, and details are not repeated herein.

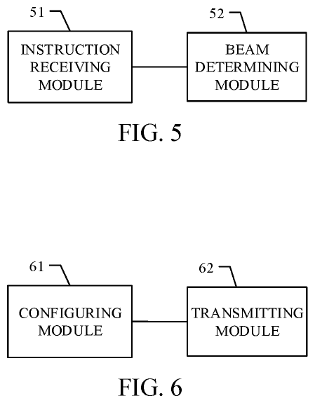

Referring to FIG. 5, FIG. 5 is a schematic structural diagram of an apparatus for common beam identification according to an embodiment of the present disclosure. The apparatus for common beam identification may include an instruction receiving module 51 and a beam determining module 52.

The instruction receiving module 51 is configured to receive a DCI instruction, the DCI instruction containing a field indicating a common beam.

The beam determining module 52 is configured to determine a downlink common beam and/or an uplink common beam according to the field indicating the common beam and MAC CE information configured by a network side.

For principles, specific embodiments, and beneficial effects of the apparatus for common beam identification, refer to the related description about the method for common beam identification as described above, and further details are not provided herein.

Referring to FIG. 6, FIG. 6 is a schematic structural diagram of another apparatus for common beam identification according to an embodiment of the present disclosure. The apparatus for common beam identification may include a configuring module 61 and a transmitting module 62.

The configuring module 61 is configured to configure MAC CE information.

The transmitting module 62 is configured to transmit a DCI instruction, the DCI instruction containing a field indicating a common beam, to cause a UE to determine a downlink common beam and/or an uplink common beam according to the field indicating the common beam and the MAC CE information.

For principles, specific embodiments, and beneficial effects of the apparatus for common beam identification, refer to the related description about the method for common beam identification as described above, and further details are not provided herein.

It should be noted that, the technical solutions of the present disclosure may be applicable to a 5G (the 5th Generation) communication system, may also be applicable to 4G and 3G communication systems, and may also be applicable to various new communication systems in the future, such as 6G and 7G.

Embodiments of the present disclosure also provides a computer-readable storage medium, on which a computer program is stored, where the computer program executes the described method when being run by a processor. The storage medium may be a computer-readable storage medium, and may include, for example, a non-volatile memory or a non-transitory memory, and may also include an optical disk, a mechanical hard disk, a solid state hard disk, and the like.

Specifically, in the embodiments of the present disclosure, the processor may be a central processing unit (CPU for short), and the processor may also be another general-purpose processor, a digital signal processor (DSP for short), an application specific integrated circuit (ASIC for short), a field programmable gate array (FPGA for short), another programmable logic device, a discrete gate or transistor logic device, a discrete hardware component, or the like. The general-purpose processor may be a microprocessor, or the processor may also be any conventional processor.

It should also be understood that the memory in the embodiments of the present disclosure may be a volatile memory or a non-volatile memory, or may include both volatile and non-volatile memories. The non-volatile memory may be a read-only memory (ROM for short), a programmable read-only memory (PROM for short), an erasable PROM (EPROM for short), an electrically EPROM (EEPROM for short), or a flash memory. The volatile memory may be a random access memory (RAM), which serves as an external cache. By way of example, and not limitation, many forms of random access memory (RAM) are available, for example, a static RAM (SRAM), a dynamic RAM (DRAM), and a synchronous DRAM (SDRAM), a double data rate SDRAM (DDR SDRAM), and an enhanced SDRAM (ESDRAM), a Synchlink DRAM (SLDRAM) and direct memory bus RAM (DR RAM).

Embodiments of the present disclosure also provide a terminal including a memory and a processor, where the memory stores a computer program capable of running on the processor, and the processor executes the operations of the described method when running the computer program. The terminal includes, but is not limited to, a terminal device such as a mobile phone, a computer, or a tablet computer.

Specifically, the terminal in the embodiments of the present disclosure may refer to various forms of user equipment (UE), an access terminal, a user unit, a user station, a mobile station, a mobile station (MS), a remote station, a remote terminal, a mobile device, a user terminal, a terminal equipment, a wireless communication device, a user agent, or a user apparatus. The terminal device may also be a cell phone, a cordless phone, a session initiation protocol (SIP) phone, a wireless local loop, a WLL station, a personal digital assistant (PDA), a handheld device having a wireless communication capability, a computing device or other processing device connected to a wireless modem, a terminal device in a future 5G network, or a terminal device in a future evolved public land mobile network (PLMN), etc., to which this embodiment of the present disclosure is not limited.

Embodiments of the present disclosure further provide a network side including a memory and a processor, where the memory stores a computer program capable of running on the processor, and the processor executes the operations of the described method when running the computer program.

The network in the embodiments of the present disclosure refers to a communication network providing a communication service for the terminal, and includes a base station of a wireless access network, may also include a base station controller of the wireless access network, and may also include a device at a core network side.

The base station (BS) may also be referred to as a base station device, and is a device deployed in a radio access network (RAN) to provide a wireless communication function. For example, a device providing a base station function in a 2G network includes a base transceiver station, a device for providing a base station function in a 3G network includes a NodeB, a device for providing a base station function in a 4G network includes an evolved NodeB (eNB), a device for providing a base station function in a wireless local area network (WLAN) includes an access point (AP), and a device for providing a base station function in a 5G new radio (NR) includes gNB and ng-eNB. The gNB and the terminal communicate with each other by using the NR technology, and the ng-eNB and the terminal communicate with each other by using the evolved universal terrestrial radio access (E-UTRA) technology. Both the gNB and the ng-eNB may be connected to the 5G core network. The base station in the embodiments of the present disclosure further includes a device providing a base station function in a future new communication system, and the like.

The base station controller in the embodiments of the present disclosure is an apparatus for managing a base station, for example, a base station controller (BSC) in a 2G network, a radio network controller (RNC) in a 3G network, and may also refer to an apparatus for controlling and managing a base station in a new communication system in the future.

Although the present disclosure has been described above, the present disclosure is not limited thereto, and various changes and modifications can be made by those skilled in the art without departing from the spirit and scope of the present disclosure. Therefore, the scope of the present disclosure should be defined by the appended claims.

It should be noted that, in the foregoing embodiments, descriptions of the embodiments are focused on different points, and for a part that is not described in detail in a certain embodiment, reference may be made to related descriptions of other embodiments.

Operations in the method according to the embodiment of the present disclosure may be adjusted sequentially, combined, and deleted according to actual requirements.

The modules in the processing device according to the embodiment of the present disclosure may be combined, separated, and deleted according to actual requirements.

The embodiments described above may be implemented in whole or in part by software, hardware, firmware, or any combination thereof. When implemented using software, it may be implemented in whole or in part in the form of a computer program product including one or more computer instructions. When a computer program instruction is loaded and executed on a computer, a procedure or function according to the embodiments of the present disclosure is completely or partially generated. The computer may be a general purpose computer, a special purpose computer, a computer network, or other programmable apparatus. The computer instructions may be stored in a computer-readable storage medium or transmitted from one computer-readable storage medium to another. For example, computer instructions may be transmitted from one website, computer, server, or data center to another website, computer, server, or data center in a wired (e.g., coaxial cable, fiber, digital subscriber line) or wireless (e.g., infrared, wireless, microwave, etc.) manner. A computer-readable storage medium may be any available media that can be accessed by a computer or a data storage device such as a server, data center, or the like that includes one or more of the available media arrays. The available medium may be a magnetic medium, (e.g., floppy disk, storage disk, magnetic tape), an optical medium (e.g., DVD), or a semiconductor medium (e.g., solid state disk (SSD)), or the like.

Finally, it should be noted that the foregoing embodiments are merely intended for describing the technical solutions of the present disclosure rather than limiting the present disclosure. Although the present disclosure is described in detail with reference to the foregoing embodiments, persons of ordinary skill in the art should understand that modifications may be made to the technical solutions described in the foregoing embodiments, or equivalent replacements may be made to some or all technical features thereof. These modifications or replacements do not make the essence of the corresponding technical solutions depart from the scope of the technical solutions of the embodiments of the present disclosure.

The technical problem to be solved by the present disclosure is to provide a method and apparatus for common beam identification, a storage medium, a terminal, and a network side, which can use a media access control (MAC) control element (CE) to indicate downlink common beam information and/or uplink common beam information, so as to fill a gap in the related art.

In order to solve the technical problem, embodiments of the disclosure provide a method for common beam identification, which includes the following: receiving a downlink control information (DCI) instruction, the DCI instruction containing a field indicating a common beam; and determining a downlink common beam and/or an uplink common beam according to the field indicating the common beam and MAC CE information configured by a network side.

Optionally, determining the downlink common beam and/or the uplink common beam according to the field indicating the common beam and the MAC CE information configured by the network side includes: determining activation indication information for a common beam pair according to the MAC CE information; determining whether a common beam in the common beam pair is activated according to the activation indication information for the common beam pair; and determining the downlink common beam and/or the uplink common beam according to the field indicating the common beam and the activation indication information, where each common beam pair includes a downlink common beam and/or an uplink common beam.

Optionally, the MAC CE has a Ci field and/or a Ti field, the Ci field indicating activation indication information for a downlink common beam in an (i+1)-th common beam pair, the Ti field indicating activation indication information for an uplink common beam in the (i+1)-th common beam pair, where i is a non-negative integer.

Optionally, the MAC CE has a transmission configuration indicator (TCI) state IDi,j field, each TCI state IDi,j field indicating an j-th common beam in an (i+1)-th common beam pair, where i is a non-negative integer and j is a positive integer.

Optionally, determining the activation indication information for the common beam pair according to the MAC CE information includes: determining the TCI state IDi,j field in the MAC CE and a downlink common beam and/or an uplink common beam indicated by the TCI state IDi,j field by assigning codepoint index information of the field indicating the common beam to i; and determining activation indication information for the downlink common beam and/or the uplink common beam.

Optionally, the MAC CE has all TCI state IDi,j fields, and for each TCI state IDi,j field, activation indication information corresponding thereto is adjacent to the TCI state IDi,j field.

Optionally, the MAC CE has only TCI state IDi,j fields corresponding to activation indication information with a preset value, where the preset value is 1 or 0, and the fields corresponding to the activation indication information are arranged in sequence.

In order to solve the technical problem, embodiments of the disclosure provide a method for common beam identification, which includes the following: configuring MAC CE information; and transmitting a DCI instruction, the DCI instruction containing a field indicating a common beam, to cause a UE to determine a downlink common beam and/or an uplink common beam according to the field indicating the common beam and the MAC CE information.

Optionally, transmitting the DCI instruction includes: transmitting the DCI instruction to cause the UE to determine activation indication information for a common beam pair according to the MAC CE information, determine whether a common beam in the common beam pair is activated according to the activation indication information for the common beam pair; and determine the downlink common beam and/or the uplink common beam according to the field indicating the common beam and the activation indication information, where each common beam pair includes a downlink common beam and/or an uplink common beam.

Optionally, the MAC CE has a Ci field and/or a Ti field, the Ci field indicating activation indication information for a downlink common beam in an (i+1)-th common beam pair, the Ti field indicating activation indication information for an uplink common beam in the (i+1)-th common beam pair, where i is a non-negative integer.

Optionally, the MAC CE has a TCI state IDi,j field, each TCI state IDi,j field indicating an j-th common beam in an (i+1)-th common beam pair, where i is a non-negative integer and j is a positive integer.

Optionally, the codepoint index information of the field indicating the common beam is assigned to i, to cause the UE to determine the TCI state IDi,j field in the MAC CE and a downlink common beam and/or an uplink common beam indicated by the TCI state IDi,j field, and further determine activation indication information for the downlink common beam and/or the uplink common beam.

Optionally, the MAC CE has all TCI state IDi,j fields, and for each TCI state IDi,j field, activation indication information corresponding thereto is adjacent to the TCI state IDi,j field.

Optionally, the MAC CE has only TCI state IDi,j fields corresponding to activation indication information with a preset value, where the preset value is 1 or 0, and the fields corresponding to the activation indication information are arranged in sequence.

In order to solve the technical problem, embodiments of the disclosure provide an apparatus for common beam identification, which include an instruction receiving module configured to receive a DCI instruction, the DCI instruction containing a field indicating a common beam, and a beam determining module configured to determine a downlink common beam and/or an uplink common beam according to the field indicating the common beam and MAC CE information configured by a network side.

In order to solve the technical problem, embodiments of the disclosure provide an apparatus for common beam identification, which include a configuring module configured to configure MAC CE information, and a transmitting module configured to transmit a DCI instruction, the DCI instruction containing a field indicating a common beam, to cause a UE to determine a downlink common beam and/or an uplink common beam according to the field indicating the common beam and the MAC CE information.

In order to solve the technical problem, embodiments of the disclosure provide a storage medium storing a computer program which, when executed by a processor, implements any of the methods for common beam identification described above.

In order to solve the technical problem, embodiments of the disclosure provide a terminal including a memory and a processor, where the memory stores a computer program capable of running in the processor, and the processor performs any of the methods for common beam identification described above when executing the computer program.

In order to solve the technical problem, embodiments of the disclosure provide a network side including a memory and a processor, where the memory stores a computer program capable of running in the processor, and the processor performs any of the methods for common beam identification described above when executing the computer program.

Compared with the related art, the technical solutions in the embodiments of the disclosure have the following beneficial effects.

In the embodiments of the disclosure, the downlink common beam and/or the uplink common beam are determined according to the field indicating the common beam and the MAC CE information configured by the network side, so that the MAC CE can be used to indicate the downlink common beam information and/or the uplink common beam information, which fills the gap in the related art.

Further, by determining the activation indication information for the common beam pair according to the MAC CE information, it can be determined whether the common beam in the common beam pair is activated, so that indication of the downlink common beam information and/or the uplink common beam information by the MAC CE can be effectively achieved.

Further, by configuring that the MAC CE has the Ci field and/the Ti field, the Ci field indicating activation indication information for the downlink common beam in the (i+1)-th common beam pair, the Ti field indicating activation indication information for the uplink common beam in the (i+1)-th common beam pair, indication of the activation indication information by the MAC CE can be effectively achieved.

Further, by configuring that the MAC CE has the TCI state IDi,j field and determining the TCI state IDi,j field in the MAC CE and the downlink common beam and/or the uplink common beam indicated by the TCI state IDi,j field by assigning the codepoint index information to i, indication of the downlink common beam information and/or the uplink common beam information by the MAC CE can be effectively achieved.

Further, in a specific embodiment of the disclosure, it may be configured that the MAC CE has all TCI state IDi,j fields, and for each TCI state IDi,j field, activation indication information corresponding thereto is adjacent to the TCI state IDi,j field. In this way, the activation indication information and the TCI state IDi,j fields can be in one-to-one correspondence, which can directly indicate the respective common beam and whether the beam is activated.

Further, in a specific embodiment of the disclosure, it may be configured that the MAC CE has only TCI state IDi,j fields corresponding to activation indication information with a preset value, where the preset value is 1 or 0, and the fields corresponding to the activation indication information are arranged in sequence. In this way, the UE can determine activation states of all common beams only using some TCI state IDi,j fields, which can effectively reduce signalling overhead of the MAC CE.

1. A method for common beam identification, comprising:
receiving a downlink control information (DCI) instruction, the DCI instruction containing a field indicating a common beam; and
determining a downlink common beam and/or an uplink common beam according to the field indicating the common beam and media access control (MAC) control element (CE) information configured by a network side.

2. The method for common beam identification of claim 1, wherein determining the downlink common beam and/or the uplink common beam according to the field indicating the common beam and the MAC CE information configured by the network side comprises:
determining activation indication information for a common beam pair according to the MAC CE information, wherein each common beam pair comprises a downlink common beam and/or an uplink common beam;
determining whether a common beam in the common beam pair is activated according to the activation indication information for the common beam pair; and
determining the downlink common beam and/or the uplink common beam according to the field indicating the common beam and the activation indication information.

3. The method for common beam identification of claim 2, wherein
the MAC CE has a Cᵢ field and/or a Tᵢ field, the Cᵢ field indicating activation indication information for a downlink common beam in an (i+1)-th common beam pair, the Tᵢ field indicating activation indication information for an uplink common beam in the (i+1)-th common beam pair, wherein i is a non-negative integer.

4. The method for common beam identification of claim 2, wherein
the MAC CE has a transmission configuration indicator (TCI) state ID_{i,j} field, each TCI state ID_{i,j} field indicating an j-th common beam in an (i+1)-th common beam pair, wherein i is a non-negative integer and j is a positive integer.

5. The method for common beam identification of claim 4, wherein determining the activation indication information for the common beam pair according to the MAC CE information comprises:
determining the TCI state ID_{i,j} field in the MAC CE and a downlink common beam and/or an uplink common beam indicated by the TCI state ID_{i,j} field by assigning codepoint index information of the field indicating the common beam to i; and
determining the activation indication information for the downlink common beam and/or the uplink common beam.

6. The method for common beam identification of claim 4, wherein the MAC CE has all TCI state ID_{i,j} fields, and for each TCI state ID_{i,j} field, activation indication information corresponding thereto is adjacent to the TCI state ID_{i,j} field.

7. The method for common beam identification of claim 4, wherein the MAC CE has only TCI state ID_{i,j} fields corresponding to activation indication information with a preset value, wherein the preset value is 1 or 0, and the fields corresponding to the activation indication information are arranged in sequence.

8-14. (canceled)

15. A terminal, comprising a transceiver, a processor, and a memory storing a computer program which, when executed by the processor, causes the terminal to:
receive a downlink control information (DCI) instruction via the transceiver, the DCI instruction containing a field indicating a common beam; and
determine, via the processor, a downlink common beam and/or an uplink common beam according to the field indicating the common beam and media access control (MAC) control element (CE) information configured by a network side.

16. The terminal of claim 15, wherein the computer program causing the terminal to determine the downlink common beam and/or the uplink common beam according to the field indicating the common beam and the MAC CE information configured by the network side causes the terminal to:
determine activation indication information for a common beam pair according to the MAC CE information, wherein each common beam pair comprises a downlink common beam and/or an uplink common beam;
determine whether a common beam in the common beam pair is activated according to the activation indication information for the common beam pair; and
determine the downlink common beam and/or the uplink common beam according to the field indicating the common beam and the activation indication information.

17. The terminal of claim 16, wherein
the MAC CE has a Cᵢ field and/or a Tᵢ field, the Cᵢ field indicating activation indication information for a downlink common beam in an (i+1)-th common beam pair, the Tᵢ field indicating activation indication information for an uplink common beam in the (i+1)-th common beam pair, wherein i is a non-negative integer.

18. The terminal of claim 16, wherein
the MAC CE has a transmission configuration indicator (TCI) state ID_{i,j} field, each TCI state ID_{i,j} field indicating an j-th common beam in an (i+1)-th common beam pair, wherein i is a non-negative integer and j is a positive integer.

19. The terminal of claim 18, wherein the computer program causing the terminal to determine the activation indication information for the common beam pair according to the MAC CE causes the terminal to:
determine the TCI state ID_{i,j} field in the MAC CE and a downlink common beam and/or an uplink common beam indicated by the TCI state ID_{i,j} field by assigning codepoint index information of the field indicating the common beam to i; and
determine the activation indication information for the downlink common beam and/or the uplink common beam.

20. The terminal of claim 18, wherein the MAC CE has all TCI state ID_{i,j} fields, and for each TCI state ID_{i,j} field, activation indication information corresponding thereto is adjacent to the TCI state ID_{i,j} field.

21. The terminal of claim 18, wherein the MAC CE has only TCI state ID_{i,j} fields corresponding to activation indication information with a preset value, wherein the preset value is 1 or 0, and the fields corresponding to the activation indication information are arranged in sequence.

22-35. (canceled)

36. A non-transitory computer-readable storage medium storing a computer program which, when executed by a terminal, causes the terminal to:
receive a downlink control information (DCI) instruction, the DCI instruction containing a field indicating a common beam; and
determine a downlink common beam and/or an uplink common beam according to the field indicating the common beam and media access control (MAC) control element (CE) information configured by a network side.

37. The non-transitory computer-readable storage medium of claim 36, wherein the computer program causing the terminal to determine the downlink common beam and/or the uplink common beam according to the field indicating the common beam and the MAC CE information configured by the network side causes the terminal to:
determine activation indication information for a common beam pair according to the MAC CE information, wherein each common beam pair comprises a downlink common beam and/or an uplink common beam;
determine whether a common beam in the common beam pair is activated according to the activation indication information for the common beam pair; and
determining the downlink common beam and/or the uplink common beam according to the field indicating the common beam and the activation indication information.

38. The non-transitory computer-readable storage medium of claim 37, wherein
the MAC CE has a Cᵢ field and/or a Tᵢ field, the Cᵢ field indicating activation indication information for a downlink common beam in an (i+1)-th common beam pair, the Tᵢ field indicating activation indication information for an uplink common beam in the (i+1)-th common beam pair, wherein i is a non-negative integer.

39. The non-transitory computer-readable storage medium of claim 37, wherein
the MAC CE has a transmission configuration indicator (TCI) state ID_{i,j} field, each TCI state ID_{i,j} field indicating an j-th common beam in an (i+1)-th common beam pair, wherein i is a non-negative integer and j is a positive integer.

40. The non-transitory computer-readable storage medium of claim 39, wherein the computer program causing the terminal to determine the activation indication information for the common beam pair according to the MAC CE causes the terminal to:
determine the TCI state ID_{i,j} field in the MAC CE and a downlink common beam and/or an uplink common beam indicated by the TCI state ID_{i,j} field by assigning codepoint index information of the field indicating the common beam to i; and
determine the activation indication information for the downlink common beam and/or the uplink common beam.

41. The non-transitory computer-readable storage medium of claim 39, wherein the MAC CE has all TCI state ID_{i,j} fields, and for each TCI state ID_{i,j} field, activation indication information corresponding thereto is adjacent to the TCI state ID_{i,j} field.
